(19) United States
(12) Patent Application Publication
(10) Pub. No.: US 2026/0343495 A1
(43) Pub. Date: Oct. 29, 2026

(54) METHODS AND APPARATUSES FOR UPLINK TRANSMISSION

(71) Applicant: Lenovo (Beijing) Limited, Beijing (CN)

(72) Inventors: Yu Zhang, Beijing (CN); Haipeng Lei, Beijing (CN)

(73) Assignee: Lenovo (Beijing) Limited, Beijing (CN)

(21) Appl. No.: 18/997,326

(22) PCT Filed: Jul. 22, 2022
(86) PCT No.: PCT/CN2022/107392

§ 371 Date: Jan. 21, 2025

(51) Int. Cl. H04W 72/044; H04L 5/00; H04W 52/14; H04W 52/34; H04W 72/21; H04W 72/566

(52) U.S. Cl. CPC H04W 72/044; H04L 5/0094; H04W 52/146; H04W 52/34; H04W 72/21; H04W 72/566

(57) ABSTRACT

Disclosed are methods and apparatuses for uplink transmission. An embodiment of the present disclosure provides a user equipment (UE). The UE includes a transceiver and a processor coupled with the transceiver. The transceiver is configured to receive at least one of: a first configuration indicating a first set of resource elements (REs) corresponding to a configured grant physical uplink shared channel (CG-PUSCH) transmission, wherein the first set of REs spans a first set of resource blocks (RBs) in frequency domain; or a second configuration indicating at least three power control (PC) parameter sets corresponding to the CG-PUSCH transmission, wherein the at least three PC parameter sets at least include a first PC parameter set associated with a normal transmission power, a second PC parameter set associated with a reduced transmission power, and a third PC parameter set associated with a boosted transmission power. The processor is configured to perform at least one of: a first determination on whether a second set of RBs included in the first set of RBs is to be occupied by the CG-PUSCH transmission, wherein the second set of RBs is within a guard band; or a second determination on which PC parameter set of the at least three PC parameter sets is to be used for transmission power calculation for the CG-PUSCH transmission, wherein the first determination or the second determination is performed based on at least one of: a priority index corresponding to the CG-PUSCH transmission; an indicator received via a group common downlink control information message; a measurement result generated by a measurement procedure associated with cross link interference; or a second set of REs used for a downlink physical signal transmission, wherein the second set of REs spans a third set of RBs in frequency domain.

### TECHNICAL FIELD

The present disclosure generally relates to wireless communication technologies, and especially to methods and apparatuses for uplink transmission in a wireless network.

### BACKGROUND OF THE INVENTION

Time Division Duplexing (TDD) is widely used in wireless networks. When operating TDD in a wireless network, only one transmission direction, that is, downlink (DL) or uplink (UL) is supported in a given time duration. However, allocation of a limited time duration for the UL transmissions would result in reduced coverage and increased latency. Therefore, it would be worth allowing the simultaneous existence of DL transmissions and UL transmissions in a given time duration, a.k.a. full duplex. More specifically, subband non-overlapping full duplex (SBFD) mode can be implemented in a wireless network, that is, the network can support simultaneous UL transmissions and DL transmissions occupying the non-overlapping subbands.

However, when operating SBFD mode, there may be mutual interference, e.g., inter-subband cross-link interference (CLI) between some of the devices in the network. Thus, it is important for a network to manage the inter-subband CLI.

### SUMMARY

An embodiment of the present disclosure provides a user equipment (UE) which includes a transceiver and a processor coupled with the transceiver. The transceiver is configured to receive at least one of: a first configuration indicating a first set of resource elements (REs) corresponding to a configured grant physical uplink shared channel (CG-PUSCH) transmission, wherein the first set of REs spans a first set of resource blocks (RBs) in frequency domain; or a second configuration indicating at least three power control (PC) parameter sets corresponding to the CG-PUSCH transmission, wherein the at least three PC parameter sets at least include a first PC parameter set associated with a normal transmission power, a second PC parameter set associated with a reduced transmission power, and a third PC parameter set associated with a boosted transmission power. The processor is configured to perform at least one of: a first determination on whether a second set of RBs included in the first set of RBs is to be occupied by the CG-PUSCH transmission, wherein the second set of RBs is within a guard band; or a second determination on which PC parameter set of the at least three PC parameter sets is to be used for transmission power calculation for the CG-PUSCH transmission, wherein the first determination or the second determination is performed based on at least one of: a priority index corresponding to the CG-PUSCH transmission; an indicator received via a group common downlink control information (GC-DCI) message; a measurement result generated by a measurement procedure associated with CLI; or a second set of REs used for a DL physical signal transmission, wherein the second set of REs spans a third set of RBs in frequency domain.

In some embodiments, the transceiver is configured to receive the at least one of the first configuration or the second configuration via a higher layer signaling.

In some embodiments, the transceiver is configured to transmit an indicator indicating whether the second set of RBs is determined to be occupied by the CG-PUSCH transmission after the first determination is performed.

In some embodiments, the indicator is included in a configured grant uplink control information (CG-UCI) associated with the CG-PUSCH transmission.

In some embodiments, the priority index is determined by the UE according to a pre-defined rule.

In some embodiments, the processor is configured to determine that the second set of RBs is to be occupied by the CG-PUSCH transmission based on the priority index being equal to or greater than a threshold.

In some embodiments, the processor is configured to determine that the second set of RBs is to be occupied by the CG-PUSCH transmission based on the indicator being set to a first value.

In some embodiments, the measurement procedure is based on a first parameter, and the processor is configured to determine that the second set of RBs is to be occupied by the CG-PUSCH transmission based on the measurement result being greater than a threshold.

In some embodiments, the measurement procedure is based on a second parameter, and the processor is configured to determine that the second set of RBs is to be occupied by the CG-PUSCH transmission based on the measurement result being less than a threshold.

In some embodiments, the processor is configured to determine that the second set of RBs is not to be occupied by the CG-PUSCH transmission based on the third set of RBs being within a subband adjacent to the first set of RBs and the second set of REs at least partially overlapping with the first set of REs in time domain.

In some embodiments, the processor is configured to determine that the third PC parameter set is to be used for transmission power calculation for the CG-PUSCH transmission based on the priority index being equal to or greater than a threshold.

In some embodiments, the processor is configured to determine that the first PC parameter set or the third PC parameter set is to be used for transmission power calculation for the CG-PUSCH transmission based on the indicator being set to a first value, and to determine that the second PC parameter set is to be used for transmission power calculation for the CG-PUSCH transmission based on the indicator being set to a second value.

In some embodiments, the processor is configured to determine that the third PC parameter set is to be used for transmission power calculation for the CG-PUSCH transmission based on the indicator being set to the first value and the priority index being equal to or greater than a threshold, and to determine that the first PC parameter set is to be used for transmission power calculation for the CG-PUSCH transmission based on the indicator being set to the first value and the priority index being less than the threshold.

In some embodiments, the measurement procedure is based on a first parameter, and the processor is configured to determine that the first PC parameter set or the third PC parameter set is to be used for transmission power calculation for the CG-PUSCH transmission based on the measurement result being greater than a first threshold.

In some embodiments, the processor is configured to determine that the third PC parameter set is to be used for transmission power calculation for the CG-PUSCH transmission based on the measurement result being greater than the first threshold and the priority index being equal to or greater than a second threshold, and to determine that the first PC parameter set is to be used for transmission power calculation for the CG-PUSCH transmission based on the measurement result being greater than the first threshold and the priority index being less than the second threshold.

In some embodiments, the measurement procedure is based on a second parameter, and the processor is configured to determine that the first PC parameter set or the third PC parameter set is to be used for transmission power calculation for the CG-PUSCH transmission based on the measurement result being less than a first threshold.

In some embodiments, the processor is configured to determine that the third PC parameter set is to be used for transmission power calculation for the CG-PUSCH transmission based on the measurement result being less than the first threshold and the priority index being equal to or greater than a second threshold, and to determine that the first PC parameter set is to be used for transmission power calculation for the CG-PUSCH transmission based on the measurement result being less than the first threshold and the priority index being less than the second threshold.

In some embodiments, the processor is configured to determine that the second PC parameter set is to be used for transmission power calculation for the CG-PUSCH transmission based on the third set of RBs being within a subband adjacent to the first set of RBs and the second set of REs at least partially overlapping with the first set of REs in time domain.

In some embodiments, the guard band is located between an uplink subband and a downlink subband or is located within an uplink subband.

Another embodiment of the present disclosure provides a base station (BS) which includes a transceiver and a processor coupled with the transceiver. The transceiver is configured to: transmit at least one of: a first configuration indicating a first set of REs corresponding to a CG-PUSCH transmission, wherein the first set of REs spans a first set of RBs in frequency domain; or a second configuration indicating at least three PC parameter sets corresponding to the CG-PUSCH transmission, wherein the at least three PC parameter sets at least include a first PC parameter set associated with a normal transmission power, a second PC parameter set associated with a reduced transmission power, and a third PC parameter set associated with a boosted transmission power; and transmit at least one of: a priority index corresponding to the CG-PUSCH transmission; or a first indicator in a GC-DCI message.

In some embodiments, the first indicator indicates at least one of: whether the CG-PUSCH transmission can occupy a second set of RBs included in the first set of RBs in the case that the second set of RBs is within a guard band of a UE; or which PC parameter set of the at least three PC parameter sets should be used for transmission power calculation for the CG-PUSCH transmission.

In some embodiments, the transceiver is further configured to receive a second indicator indicating whether a second set of RBs included in the first set of RBs is to be occupied by the CG-PUSCH transmission, the second set of RBs is within a guard band of a UE.

In some embodiments, the second indicator is received in a CG-UCI associated with the CG-PUSCH transmission.

Yet another embodiment of the present disclosure provides a method performed by a UE. The method includes: a first configuration indicating a first set of REs corresponding to a CG-PUSCH transmission, wherein the first set of RES spans a first set of RBs in frequency domain; or a second configuration indicating at least three PC parameter sets corresponding to the CG-PUSCH transmission, wherein the at least three PC parameter sets at least include a first PC parameter set associated with a normal transmission power, a second PC parameter set associated with a reduced transmission power, and a third PC parameter set associated with a boosted transmission power; and performing at least one of: a first determination on whether a second set of RBs included in the first set of RBs is to be occupied by the CG-PUSCH transmission, the second set of RBs is within a guard band; or a second determination on which PC parameter set of the at least three PC parameter sets is to be used for transmission power calculation for the CG-PUSCH transmission, wherein the first determination or the second determination is performed based on at least one of: a priority index corresponding to the CG-PUSCH transmission; an indicator received via a GC-DCI message; a measurement result generated by a measurement procedure associated with CLI; or a second set of REs used for a DL physical signal transmission, wherein the second set of REs spans a third set of RBs in frequency domain.

Yet another embodiment of the present disclosure provides a method performed by a BS. The method includes: transmitting at least one of: a first configuration indicating a first set of REs corresponding to a CG-PUSCH transmission, wherein the first set of REs spans a first set of RBs in frequency domain; or a second configuration indicating at least three PC parameter sets corresponding to the CG-PUSCH transmission, wherein the at least three PC parameter sets at least include a first PC parameter set associated with a normal transmission power, a second PC parameter set associated with a reduced transmission power, and a third PC parameter set associated with a boosted transmission power; and transmitting at least one of: a priority index corresponding to the CG-PUSCH transmission; or a first indicator in a GC-DCI message.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates exemplary inter-subband CLI in a wireless communication system.

FIG. 2A and FIG. 2B illustrate examples of guard bands.

FIG. 3 illustrates a flow chart of an exemplary method performed by a UE according to some embodiments of the present disclosure.

FIG. 4 illustrates a simplified block diagram of an exemplary apparatus according to some embodiments of the present disclosure.

### DETAILED DESCRIPTION

The detailed description of the appended drawings is intended as a description of the currently preferred embodiments of the present invention and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3rd generation partnership project (3GPP) long-term evolution (LTE) and LTE Advanced, 3GPP 5G new radio (NR), 5G-Advanced, 6G and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates an exemplary wireless communication system 100 supporting the SBFD mode.

Referring to FIG. 1, the wireless communication system 100 may include one or more UEs (e.g., UE 101-a and UE 101-b, collectively referred to as UEs 101) and at least a BS 102. Although a specific number of UEs 101 and BS 102 are depicted in FIG. 1, it is contemplated that any number of UEs and BSs may be included in the wireless communication system 100.

In some embodiments of the present disclosure, the UEs 101 may be devices in various forms or having various capabilities. According to some embodiments of the present disclosure, the UEs 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UEs 101 may include portable wireless communication devices, such as smart phones, cellular telephones, flip phones, or any other device that is capable of transmitting and receiving information. In some embodiments, the UEs 101 may include wearable devices, such as smart watches, fitness bands, optical head-mounted displays, or the like. Moreover, each of the UEs 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present disclosure, the BS 102 may be referred to as an access point, an access terminal, a base, a base unit, a macro cell, a Node B, an enhanced Node B, an evolved Node B, a next generation Node B (gNB), a Home Node B, a relay node, or a device, or described using other terminology used in the art. The BS 102 is generally a part of a radio access network that may include a controller communicably coupled to the BS 102.

The wireless communication system 100 may be compatible with any type of network that is capable of exchanging information between the BS 102 and the UEs 101. For example, the wireless communication system 100 may be a cellular telephone network, a time division multiple access (TDMA)-based network, a code division multiple access (CDMA)-based network, an orthogonal frequency division multiple access (OFDMA)-based network, a 3GPP-based network, a 3GPP LTE network, a 3GPP 5G NR network, a satellite communications network, a high-altitude platform network, or one of other communications networks. More generally, however, the wireless communication system 100 may implement some other open or proprietary communication protocols, for example, IEEE 802.11 family, WiMAX, among other protocols.

In some embodiments of the present disclosure, the BS 102 may be dispersed throughout a geographic area to form the wireless communication system 100 and may be a device in various forms or having various capabilities. The information exchanges between the BS 102 and the UEs 101 in the wireless communication system 100 may include UL transmissions (e.g., UL transmission 103 from the UE 101-a to the BS 102), and DL transmissions (e.g., DL transmission 104 from the BS 102 to the UE 101-b) over one or more carriers. A carrier may be a portion of a radio frequency spectrum band and may be associated with a particular bandwidth (e.g., 20 megahertz (MHz)). A carrier may be made up of multiple subcarriers and a resource block (RB) is defined as 12 consecutive subcarriers. In some examples, there may be multiple subbands within a carrier and each subband may include a number of consecutive RBs. The time intervals for the wireless communication system 100 may be expressed in multiples of a basic time unit and may be organized according to radio frames each having a specified duration (e.g., 10 milliseconds (ms)). In some examples, a radio frame may be divided into subframes, and each subframe may be further divided into a number of slots. Alternatively, each radio frame may include a variable number of slots and each slot includes a number of symbols (e.g., 14 symbols). The UL and DL transmissions may include physical channel transmissions and physical signal transmissions. A physical channel transmission or a physical signal transmission is transmitted on a set of basic time-frequency domain resources having a defined physical layer structure. Each basic time-frequency domain resource may be referred to as a resource element (RE) which may consist of one symbol in time domain and one subcarrier in frequency domain. A set of REs where a physical channel transmission or a physical signal transmission is transmitted may span a number of symbols in time domain and a number of subcarriers within one or more subbands in frequency domain, that is, the physical channel transmission or the physical signal transmission may occupy a number of symbols and a number of subcarriers within one or more subbands.

In some embodiments of the present disclosure, for the wireless communication system 100, the UEs 101 may receive a configuration from the BS 102 via a higher layer signaling for one or more UL physical channel transmissions, wherein the configuration may also be referred to as configured grant (CG) configuration, and the one or more UL physical channel transmissions may also be referred to as CG-PUSCH transmissions. The CG configuration may indicate a set of REs corresponding to an individual CG-PUSCH transmission of the one or more CG-PUSCH transmissions, that is, the individual CG-PUSCH transmission can be performed on the set of REs. The set of REs may span a number of symbols in time domain and a number of RBs within one or more subbands in frequency domain, that is, the individual CG-PUSCH transmission may occupy a number of symbols and a number of RBs within one or more subbands.

In the context of the present disclosure, for UEs 101, transmitting a UL transmission may also be referred to as performing a UL transmission or the like, and receiving a DL transmission may also be referred to as performing a DL reception or the like.

The physical signal transmissions may include reference signal (RS) transmissions, which are used for measurement. A measurement procedure can be performed based on one or more parameters obtained based on the RS transmissions.

In the wireless communication system 100, the SBFD mode is supported, that is, there may be simultaneous UL transmission(s) (e.g., UL transmission 103 from the UE 101-a to the BS 102 within UL subband a) and DL transmission(s) (e.g., DL transmission 104 from the BS 102 to the UE 101-b within DL subband b), wherein UL subband a and DL subband b are two non-overlapping adjacent subbands within a carrier. However, the UL transmission 103 transmitted from the UE 101-a may also arrive at the UE 101-b, which may cause interference to the reception of the DL transmission 104 at the UE 101-b. In other words, there may be inter-subband CLI 105 between the UE 101-a and the UE 101-b in the wireless communication system 100, and the UE 101-a may be referred to as an aggressor UE in this case.

To reduce or avoid the inter-subband CLI (e.g., CLI 105), the BS 102 may plan a suitable schedule of the simultaneous transmissions in the wireless communication system 100. However, the BS may not always know whether there is inter-subband CLI between the UEs in advance, i.e., the BS may not always know which UE(s) may cause inter-subband CLI on other UE(s); for example, the BS may not know the existence of inter-subband CLI 105 during a time duration.

The present disclosure provides solutions to reduce or mitigate the negative effect of inter-subband CLI (e.g., the inter-subband CLI 105) in the network (e.g., wireless communication system 100).

According to some embodiments of the present disclosure, a guard band is introduced to mitigate the inter-subband CLI in the network (e.g., the wireless communication system 100). In some embodiments, a guard band consists of several RBs and is located between a UL subband and a DL subband, wherein the UL subband and the DL subband are adjacent non-overlapping subbands within a carrier. In some embodiments, a guard band is located in an edge of a UL subband and is adjacent to a DL subband, wherein the UL subband and the DL subband are adjacent non-overlapping subbands within a carrier. The UE may determine whether a CG-PUSCH transmission can occupy the RB(s) within the guard band based on certain rules.

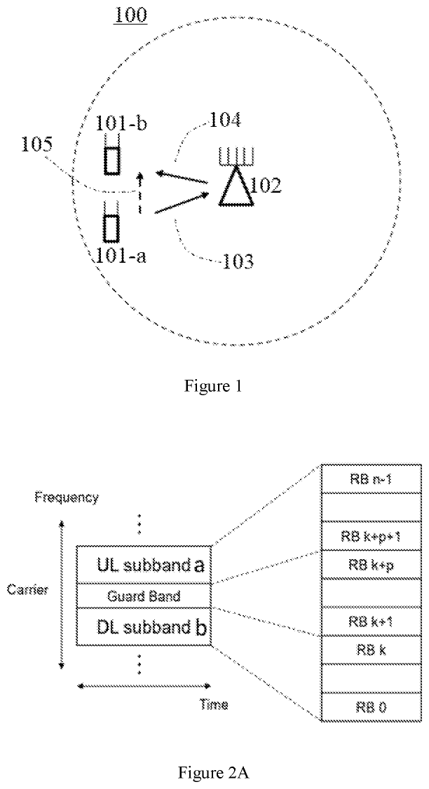

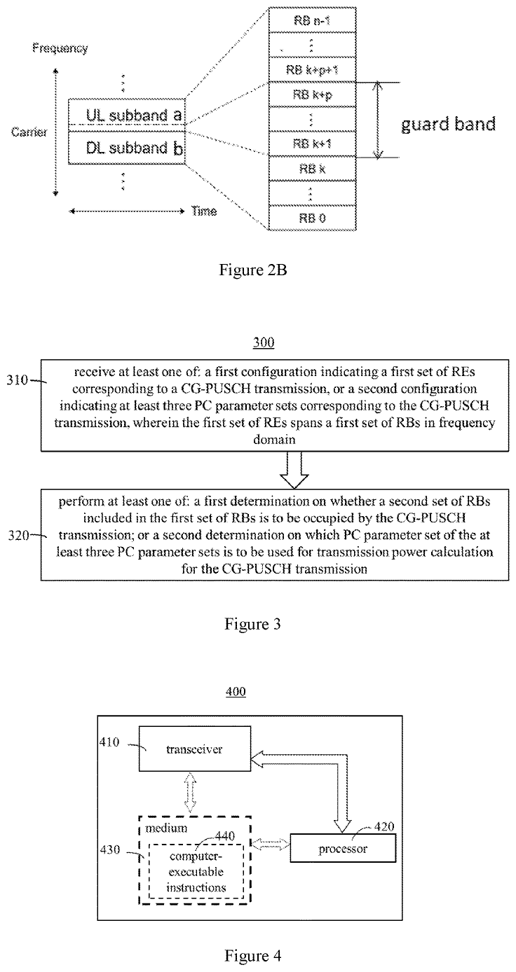

FIG. 2A and FIG. 2B illustrate examples of guard bands.

In the example as shown in FIG. 2A, a UE may determine that there are UL subband a and DL subband b within a carrier, and there is a guard band located between the UL subband a and the DL subband b during a time duration (e.g., a set of symbols). The UL subband a consists of RB k+p+1 to RB n−1, the guard band consists of RB k+1 to RB k+p, and the DL subband b consists of RB 0 to RB k, where k is a non-negative integer, n and p are positive integers, and (n−k)>(p+2).

In the example as shown in FIG. 2B, a UE may determine that there are UL subband a and DL subband b within a carrier, and there is a guard band located in the lower edge of the UL subband a and adjacent to the DL subband b during a time duration (e.g., a set of symbols). The UL subband a consists of RB k+1 to RB n−1, the DL subband b consists of RB 0 to RB k, and the guard band consists of RB k+1 to RB k+p, where k is a non-negative integer, n and p are positive integers, and (n−k)≥(p+2).

According to some embodiments of the present disclosure, reducing the transmission power used for the UL transmission is another way to mitigate the inter-subband CLI. The UE may be provided by another configuration with at least three PC parameter sets for transmission power calculation for UL transmission (e.g., CG-PUSCH transmission), wherein the another configuration may also be referred to as PC configuration and the at least three PC parameter sets at least include a first PC parameter set associated with a normal transmission power, a second PC parameter set associated with a reduced transmission power, and a third PC parameter set associated with a boosted transmission power. The UE may determine which PC parameter set of the at least three PC parameter sets is to be used for transmission power calculation for a CG-PUSCH transmission based on certain rules.

FIG. 3 illustrates a flowchart of an exemplary method 300 performed by a UE (e.g., UE 101-a or UE 101-b in FIG. 1) according to some embodiments of the present disclosure. Although method 300 is described herein with respect to a UE, it is contemplated that method 300 can be performed by other device with similar functionality.

In step 310, the UE may receive at least one of: a first configuration indicating a first set of REs corresponding to a CG-PUSCH transmission, wherein the first set of REs spans a first set of RBs in frequency domain (i.e., the CG-PUSCH transmission may occupy the first set of RBs in frequency domain); or a second configuration indicating at least three PC parameter sets corresponding to the CG-PUSCH transmission. The at least three PC parameter sets are used for transmission power calculation for the CG-PUSCH transmission, wherein the at least three PC parameter sets at least include a first PC parameter set associated with a normal transmission power, a second PC parameter set associated with a reduced transmission power, and a third PC parameter set associated with a boosted transmission power.

In some embodiments, the UE may receive the at least one of the first configuration or the second configuration via a higher layer signaling, e.g., RRC signaling.

As shown in FIG. 3, in step 320, the UE may perform at least one of: a first determination on whether a second set of RBs included in the first set of RBs is to be occupied by the CG-PUSCH transmission, wherein the second set of RBs is within a guard band; or a second determination on which PC parameter set of the at least three PC parameter sets is to be used for transmission power calculation for the CG-PUSCH transmission.

For example, the UE may determine UL subband a, DL subband b, and a guard band within a carrier as shown in FIG. 2A, and receive the first configuration indicating the first set of REs corresponding to the CG-PUSCH transmission in step 310. The first set of REs may span a first set of RBs (e.g., RB k+1 to RB n−1) in frequency domain, which includes some RBs (e.g., RB k+p+1 to RB n−1) within the UL subband a and a second set of RBs (e.g., RB k+1 to RB k+p) within the guard band. The UE may determine whether the second set of RBs is to be occupied by the CG-PUSCH transmission based on certain rules in step 320. Upon determination of whether the second set of RBs is to be occupied by the CG-PUSCH transmission, the UE may determine whether the REs of the first set of REs that correspond to the second set of RBs are to be occupied by the CG-PUSCH transmission.

As another example, the UE may receive the second configuration indicating the at least three PC parameter sets corresponding to the CG-PUSCH transmission in step 310. In step 320, the UE may determine which PC parameter set of the at least three PC parameter sets is to be used for transmission power calculation for the CG-PUSCH transmission based on certain rules.

In some embodiments, in step 310, the UE may receive both the first configuration and the second configuration; in step 320, the UE may determine which PC parameter set of the at least three PC parameter sets is to be used for transmission power calculation for the CG-PUSCH transmission, and determine whether the second set of RBs is to be occupied by the CG-PUSCH transmission.

According to some embodiments, the UE may determine whether the second set of RBs is to be occupied by the CG-PUSCH transmission or determine which PC parameter set of the at least three PC parameter sets is to be used for transmission power calculation for the CG-PUSCH transmission based on at least one of:
a priority index corresponding to the CG-PUSCH transmission, wherein the priority index may be determined by the UE according to a pre-defined rule, or indicated by the first configuration;
an indicator received via, e.g., a GC-DCI message;
a measurement result generated by a measurement procedure associated with CLI; or
a second set of REs used for a DL physical signal transmission, wherein the second set of REs spans a third set of RBs in frequency domain.

According to some embodiments of the present disclosure, the UE may determine whether the second set of RBs is to be used for the CG-PUSCH transmission and/or determine which PC parameter set of the at least three PC parameter sets is to be used for transmission power calculation for the CG-PUSCH transmission according to at least the priority index corresponding to the CG-PUSCH transmission.

For example, the UE may compare the priority index with a configured or pre-configured priority index threshold.

In some embodiments, in the case that the priority index is equal to or greater than the priority index threshold, which means that the CG-PUSCH transmission corresponds to a high priority and should occupy more RBs in frequency domain, the UE may determine that the second set of RBs is to be occupied by the CG-PUSCH transmission.

In some other embodiments, in the case that the priority index is equal to or greater than the priority index threshold, which means that the CG-PUSCH transmission corresponds to a high priority and should be transmitted using a boosted transmission power, the UE may determine that the third PC parameter set is to be used for transmission power calculation for the CG-PUSCH transmission.

In some other embodiments, in the case that the priority index is equal to or greater than the priority index threshold, which means that the CG-PUSCH transmission corresponds to a high priority, and should occupy more RBs in frequency domain and be transmitted using a boosted transmission power, the UE may determine that the second set of RBs is to be occupied by the CG-PUSCH transmission, and determine that the third PC parameter set is to be used for transmission power calculation for the CG-PUSCH transmission.

In the case that the priority index is less than the priority index threshold, the UE may determine that the second set of RBs is not to be occupied by the CG-PUSCH transmission or determine whether the second set of RBs is to be occupied by the CG-PUSCH transmission based on other rules. Similarly, in such case, the UE may determine that the first PC parameter set or the second PC parameter set is to be used for transmission power calculation for the CG-PUSCH transmission or determine which PC parameter set is to be used based on other rules.

According to some embodiments of the present disclosure, the UE may determine whether the second set of RBs is to be used for the CG-PUSCH transmission and/or determine which PC parameter set of the at least three PC parameter sets is to be used for transmission power calculation for the CG-PUSCH transmission based on the indicator received via, e.g., a GC-DCI message.

In some embodiments, if the BS (e.g., BS 102) can guarantee that a UL transmission from the UE (e.g., UE 101-a) occupying the guard band and/or not using reduced transmission power will not cause CLI to the DL reception(s) of other UE(s) (e.g., UE 101-b) on the adjacent DL subband(s), e.g., by properly scheduling, then the indicator in, e.g., the GC-DCI message will be set to a first value (e.g., “1”). If the BS cannot make such guarantee, the indicator will be set to a second value (e.g., “0”).

In some embodiments, in the case that the indicator is set to the first value, the UE may determine that the second set of RBs is to be occupied by the CG-PUSCH transmission. In some embodiments, in the case that the indicator is set to the second value, the UE may determine that the second set of RBs is not to be occupied by the CG-PUSCH transmission or determine whether the second set of RBs is to be occupied by the CG-PUSCH transmission based on other rules.

In some embodiments, in the case that the indicator is set to the first value, the UE may determine that the first PC parameter set or the third PC parameter set is to be used for transmission power calculation for the CG-PUSCH transmission. In some embodiments, in the case that the indicator is set to the second value, the UE may determine that the second PC parameter set is to be used for transmission power calculation for the CG-PUSCH transmission or determine which PC parameter set to be used for transmission power calculation for the CG-PUSCH transmission based on other rules.

In some embodiments, in the case that the indicator is set to the first value, the UE may determine that the second set of RBs is to be occupied by the CG-PUSCH transmission, and the first PC parameter set or the third PC parameter set is to be used for transmission power calculation for the CG-PUSCH transmission.

In some embodiments, in the case that the indicator is set to the first value, and the priority index corresponding to the CG-PUSCH transmission is equal to or greater than the priority index threshold, the UE may determine that the third PC parameter set is to be used for transmission power calculation for the CG-PUSCH transmission. In some embodiments, in the case that the indicator is set to the first value, and the priority index corresponding to the CG-PUSCH transmission is less than the priority index threshold, the UE may determine that the first PC parameter set is to be used for transmission power calculation for the CG-PUSCH transmission.

According to some embodiments of the present disclosure, the UE may perform a measurement procedure to obtain a measurement result associated with CLI (e.g., inter-subband CLI caused by other UE(s) to the UE). If the measurement result shows that no or weak inter-subband CLI exists, the UE may presume that the UE will not cause inter-subband CLI to other UE(s). That is, based on the measurement result, the UE may evaluate its inter-subband CLI to DL reception(s) of other UE(s) on the adjacent subband(s) in the network, and determine whether the second set of RBs is to be occupied by the CG-PUSCH transmission and/or which PC parameter set is to be used for transmission power calculation for the CG-PUSCH transmission.

For example, the UE may compare the measurement result with a configured or pre-configured measurement result threshold.

In some embodiments, the measurement procedure is based on a first parameter, e.g., signal to interference plus noise ratio (SINR), and the measurement result threshold is a first parameter threshold. In the case that the measurement result generated by the measurement procedure is greater than the first parameter threshold, which may indicate that no or weak inter-subband CLI exists, the CG-PUSCH transmission can occupy more RBs in frequency domain and/or a normal or a boosted transmission power can be used for the CG-PUSCH transmission. In such case, in some embodiments, the UE may determine that the second set of RBs is to be occupied by the CG-PUSCH transmission; in some embodiments, the UE may determine that the first PC parameter set or the third PC parameter set is to be used for transmission power calculation for the CG-PUSCH transmission; and in some embodiments, the UE may determine that the second set of RBs is to be occupied by the CG-PUSCH transmission, and the first PC parameter set or the third PC parameter set is to be used for transmission power calculation for the CG-PUSCH transmission.

In some embodiments, in the case that the measurement result associated with the first parameter is greater than the first parameter threshold, and the priority index corresponding to the CG-PUSCH transmission is equal to or greater than the priority index threshold, the UE may determine that the CG-PUSCH transmission may be performed with a boosted power, i.e., the UE may determine that the third PC parameter set is to be used for transmission power calculation for the CG-PUSCH transmission. In some embodiments, in the case that the measurement result associated with the first parameter is greater than the first parameter threshold, and the priority index corresponding to the CG-PUSCH transmission is less than the priority index threshold, the UE may determine that the CG-PUSCH transmission may be performed with a normal power, i.e., the UE may determine that the first PC parameter set is to be used for transmission power calculation for the CG-PUSCH transmission.

In some embodiments, the measurement procedure is based on a second parameter, e.g., sounding reference signal (SRS) reference signal received power (RSRP), and the measurement result threshold is a second parameter threshold. In the case that the measurement result generated by the measurement procedure is less than the second parameter threshold, which may indicate that no or weak inter-subband CLI exists, the CG-PUSCH transmission can occupy more RBs in frequency domain or a normal or a boosted transmission power can be used for the CG-PUSCH transmission. In such case, in some embodiments, the UE may determine that the second set of RBs is to be occupied by the CG-PUSCH transmission; in some embodiments, the UE may determine that the first PC parameter set or the third PC parameter set is to be used for transmission power calculation for the CG-PUSCH transmission; and in some embodiments, the UE may determine that the second set of RBs is to be occupied by the CG-PUSCH transmission, and the first PC parameter set or the third PC parameter set is to be used for transmission power calculation for the CG-PUSCH transmission.

In some embodiments, in the case that the measurement result associated with the second parameter is less than the second parameter threshold, and the priority index corresponding to the CG-PUSCH transmission is equal to or greater than the priority index threshold, the UE may determine that the CG-PUSCH transmission may be performed with a boosted power, i.e., the UE may determine that the third PC parameter set is to be used for transmission power calculation for the CG-PUSCH transmission. In some embodiments, in the case that the measurement result associated with the second parameter is less than the second parameter threshold, and the priority index corresponding to the CG-PUSCH transmission is less than the priority index threshold, the UE may determine that the CG-PUSCH transmission may be performed with a normal power, i.e., the UE may determine that the first PC parameter set is to be used for transmission power calculation for the CG-PUSCH transmission.

According to some embodiments of the present disclosure, the UE may be configured with a second set of REs for a DL physical signal (e.g., SSB) transmission, wherein the second set of REs spans a third set of RBs in frequency domain. The third set of RBs may be within a DL subband adjacent to the UL subband where the first set of RBs locates. For example, the first set of RBs may consist of a number of RBs within the UL subband a and the guard band (e.g., RB k+1 to RB n−1) as shown in FIG. 2A, and the third set of RBs may consist of a number of RBs within the DL subband b (e.g., RB 0 to RB k) as shown in FIG. 2A. In some embodiments, the UE may receive a configuration indicating the second set of REs via a higher layer signaling. In some cases, due to importance of a successful reception of the DL physical signal (e.g., SSB), the UE may try to avoid inter-subband CLI to the DL physical signal reception on the third set of RBs.

In some embodiments, in the case that the third set of RBs is within a subband adjacent to the first set of RBs and the second set of REs partially or fully overlaps with the first set of REs in time domain, the UE may determine that the second set of RBs is not to be occupied by the CG-PUSCH transmission, or determine that the second PC parameter set is to be used for transmission power calculation for the CG-PUSCH transmission, or determine the both.

According to some embodiments of the present disclosure, after the UE (e.g., UE 101-a or UE 101-b) determines whether the second set of RBs is to be used by the CG-PUSCH transmission, the UE may transmit a guard band usage indicator to the BS (e.g., BS 102) to notify the determination. In some embodiments, the guard band usage indicator is included in a CG-UCI associated with the CG-PUSCH transmission. The CG-UCI is not mapped within the guard band, so that the BS can decode the CG-UCI without prior knowledge of whether the guard band is used. After decoding the CG-UCI, the BS may check the guard band usage indicator and then decode the CG-PUSCH transmission based on at least the guard band usage indicator.

In some embodiments, after determining the PC parameter set to be used for transmission power calculation for the CG-PUSCH transmission, the UE may indicate the determined PC parameter set to the BS via, e.g., the CG-UCI associated with the CG-PUSCH.

It would be contemplated that a BS may perform methods corresponding to the aforementioned methods performed by a UE.

According to some embodiments of the present disclosure, the BS (e.g., BS 102) may transmit at least one of: a first configuration indicating a first set of REs corresponding to a CG-PUSCH transmission, wherein the first set of REs spans a first set of RBs in frequency domain; or a second configuration indicating at least three PC parameter sets corresponding to the CG-PUSCH transmission. The at least three PC parameter sets may at least include a first PC parameter set associated with a normal transmission power, a second PC parameter set associated with a reduced transmission power, and a third PC parameter set associated with a boosted transmission power. In some embodiments, the BS may transmit at least one of the first configuration or the second configuration via a higher layer signaling, e.g., RRC signaling.

The first set of RBs may include a second set of RBs which is within a guard band. In some embodiments, the guard band may be located between a UL subband and a DL subband within a carrier as shown in FIG. 2A. In some embodiments, the guard band may be located in an edge of a UL subband and adjacent to a DL subband as shown in FIG. 2B.

In some embodiments, the BS may further transmit at least one of: a priority index corresponding to the CG-PUSCH transmission; or an indicator in, e.g., a GC-DCI message, wherein the indicator indicates at least one of: whether the CG-PUSCH transmission can occupy a second set of RBs included in the first set of RBs in the case that the second set of RBs is within a guard band of a UE; or which PC parameter set of the at least three PC parameter sets should be used for transmission power calculation for the CG-PUSCH transmission. The UE may determine whether to use the second set of RBs within the guard band for performing the CG-PUSCH transmission and/or determine which PC parameter set to be used for transmission power calculation for the CG-PUSCH transmission based at least on the priority index and/or the indicator, according to any of the methods as described above.

In some embodiments, the BS may receive a guard band usage indicator from the UE (e.g., UE 101-a or UE 101-b). The guard band usage indicator may indicate the UE's determination regarding whether the second set of RBs included in the first set of RBs and within the guard band of the UE is to be occupied by the CG-PUSCH transmission. In some embodiments, the BS may receive the guard band usage indicator via a CG-UCI associated with the CG-PUSCH transmission, wherein the CG-UCI is transmitted without occupying the guard band in frequency domain.

In some embodiments, the BS may receive an indicator indicating the UE's determination regarding which PC parameter set of the at least three PC parameter sets is to be used for transmission power calculation for the CG-PUSCH transmission. The indicator may be included in a CG-UCI associated with the CG-PUSCH transmission.

Although solutions regarding mitigating CLI in a network supporting SBFD mode is specifically described, it is contemplated that similar solutions may apply to mitigating CLI in the network as well.

FIG. 4 illustrates a simplified block diagram of an exemplary apparatus 400 according to various embodiments of the present disclosure.

In some embodiments, the apparatus 400 may be or include at least a part of a UE (e.g., UE 101a or UE 101b) or similar device that can use the technology of the present disclosure.

In some embodiments, the apparatus 400 may be or include at least a part of a BS (e.g., BS 102) or similar device that can use the technology of the present disclosure.

As shown in FIG. 4, the apparatus 400 may include at least a transceiver 410 and a processor 420, wherein the transceiver 410 may be coupled to the processor 420. In some embodiments, the transceiver 410 may include a transmitter and a receiver integrated together. In some embodiments, the transceiver 410 may include a transmitter and a receiver which are separated from each other. In some embodiments, the transceiver 410 may be a wireless transceiver.

In some embodiments, the apparatus 400 may include a non-transitory computer-readable medium 430 with computer-executable instructions 440 stored thereon. The non-transitory computer-readable medium 430 may be coupled to the processor 420, and the computer-executable instructions 440 may be configured to be executable by the processor 420. In some embodiments, the transceiver 410, the non-transitory computer-readable medium 430, and the processor 420 may be coupled to each other via one or more local buses.

Although in FIG. 4, elements such as the transceiver 410, the non-transitory computer-readable medium 430, and the processor 420 are described in the singular, the plural is contemplated unless limitation to the singular is explicitly stated. In certain embodiments of the present disclosure, the apparatus 400 may further include other components for actual usage.

In some embodiments, the apparatus 400 is a UE or at least a part of a UE. The processor 420 is configured to cause the apparatus 400 to perform, with the transceiver 410, any method described above which is performed by a UE (e.g., UE 101-a or UE 101-b) according to the present disclosure. For example, the transceiver 410 may be configured to receive at least one of: a first configuration indicating a first set of REs corresponding to a CG-PUSCH transmission, wherein the first set of REs spans a first set of RBs in frequency domain; or a second configuration indicating at least three PC parameter sets corresponding to the CG-PUSCH transmission. The processor 420 may be configured to perform at least one of: a first determination on whether a second set of RBs included in the first set of RBs is to be occupied by the CG-PUSCH transmission, wherein the second set of RBs is within a guard band (e.g., the guard band shown in FIG. 2A or FIG. 2B); or a second determination on which PC parameter set of the at least three PC parameter sets is to be used for transmission power calculation for the CG-PUSCH transmission.

In some embodiments, the apparatus 400 is a BS or at least a part of a BS (e.g., BS 102). The processor 420 is configured to cause the apparatus 400 to perform, with the transceiver 410, any method described above which is performed by a BS according to the present disclosure. For example, the transceiver 410 may be configured to: transmit at least one of: a first configuration indicating a first set of REs corresponding to a CG-PUSCH transmission, wherein the first set of REs spans a first set of RBs in frequency domain; or a second configuration indicating at least three PC parameter sets corresponding to the CG-PUSCH transmission; and transmit at least one of: a priority index corresponding to the CG-PUSCH transmission; or a first indicator in a GC-DCI message.

In various example embodiments, the processor 420 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 420 may also include at least one other circuitry or element not shown in FIG. 4.

In various example embodiments, the non-transitory computer-readable medium 430 may include at least one storage medium in various forms, such as a volatile memory and/or a non-volatile memory. The volatile memory may include, but is not limited to, for example, a RAM, a cache, and so on. The non-volatile memory may include, but is not limited to, for example, a ROM, a hard disk, a flash memory, and so on. Further, the non-transitory computer-readable medium 430 may include, but is not limited to, an electric, a magnetic, an optical, an electromagnetic, an infrared, or a semiconductor system, apparatus, or device or any combination of the above.

Further, in various example embodiments, the exemplary apparatus 400 may also include at least one other circuitry, element, and interface, for example antenna element, and the like.

In various example embodiments, the circuitries, parts, elements, and interfaces in the exemplary apparatus 400, including the transceiver 410, the processor 420 and the non-transitory computer-readable medium 430, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.” In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to cause the UE to:
receive at least one of:
a first configuration indicating a first set of resource elements (REs) corresponding to a configured grant physical uplink shared channel (CG-PUSCH) transmission, wherein the first set of REs spans a first set of resource blocks (RBs) in frequency domain; or
a second configuration indicating at least three power control (PC) parameter sets corresponding to the CG-PUSCH transmission, wherein the at least three PC parameter sets include at least a first PC parameter set associated with a normal transmission power, a second PC parameter set associated with a reduced transmission power, and a third PC parameter set associated with a boosted transmission power; and
a processor perform at least one of:
a first determination of whether a second set of RBs included in the first set of RBs is to be occupied by the CG-PUSCH transmission, wherein the second set of RBs is within a guard band; or
a second determination as to which PC parameter set of the at least three PC parameter sets is to be used for transmission power calculation for the CG-PUSCH transmission,
wherein the first determination or the second determination is performed based on at least one of:
a priority index corresponding to the CG-PUSCH transmission;
an indicator received via a group common downlink control information (GC-DCI) message;
a measurement result generated by a measurement procedure associated with cross link interference (CLI); or
a second set of REs used for a downlink physical signal transmission, wherein the second set of REs spans a third set of RBs in frequency domain.

2. The UE of claim 1, wherein the at least one processor is configured to cause the UE to receive the at least one of the first configuration or the second configuration via a higher layer signaling.

3. The UE of claim 1, wherein the at least one processor is configured to cause the UE to transmit an indicator indicating whether the second set of RBs is determined to be occupied by the CG-PUSCH transmission after the first determination is performed.

4. The UE of claim 3, wherein the indicator is included in a configured grant uplink control information (CG-UCI) associated with the CG-PUSCH transmission.

5. The UE of claim 1, wherein the at least one processor is configured to cause the UE to determine that the second set of RBs is to be occupied by the CG-PUSCH transmission based on the priority index being equal to or greater than a threshold.

6. The UE of claim 1, wherein the at least one processor is configured to cause the UE to determine that the second set of RBs is to be occupied by the CG-PUSCH transmission based on the indicator being set to a first value.

7. The UE of claim 1, wherein the measurement procedure is based on a first parameter, and wherein the at least one processor is configured to cause the UE to determine that the second set of RBs is to be occupied by the CG-PUSCH transmission based on the measurement result being greater than a threshold.

8. The UE of claim 1, wherein the at least one processor is configured to cause the UE to determine that the second set of RBs is not to be occupied by the CG-PUSCH transmission based on the third set of RBs being within a subband adjacent to the first set of RBs and the second set of REs at least partially overlapping with the first set of REs in time domain.

9. The UE of claim 1, wherein the at least one processor is configured to cause the UE to determine that the third PC parameter set is to be used for the transmission power calculation for the CG-PUSCH transmission based on the priority index being equal to or greater than a threshold.

10. The UE of claim 1, wherein the at least one processor is configured to cause the UE to determine that the first PC parameter set or the third PC parameter set is to be used for the transmission power calculation for the CG-PUSCH transmission based on the indicator being set to a first value, and to determine that the second PC parameter set is to be used for the transmission power calculation for the CG-PUSCH transmission based on the indicator being set to a second value.

11. The UE of claim 1, wherein the measurement procedure is based on a first parameter, and wherein the at least one processor is configured to cause the UE to determine that the first PC parameter set or the third PC parameter set is to be used for the transmission power calculation for the CG-PUSCH transmission based on the measurement result being greater than a first threshold.

12. The UE of claim 1, wherein the at least one processor is configured to cause the UE to determine that the second PC parameter set is to be used for the transmission power calculation for the CG-PUSCH transmission based on the third set of RBs being within a subband adjacent to the first set of RBs and the second set of REs at least partially overlapping with the first set of REs in time domain.

13. The UE of claim 1, wherein the guard band is located between an uplink subband and a downlink subband or is located within an uplink subband.

14. A base station (BS) for wireless communication, comprising:
at least one memory; and
at least one processor coupled with the at least one memory and configured to cause the BS to:
transmit at least one of:
a first configuration indicating a first set of resource elements (REs) corresponding to a configured grant physical uplink shared channel (CG-PUSCH) transmission, wherein the first set of REs spans a first set of resource blocks (RBs) in frequency domain; or
a second configuration indicating at least three power control (PC) parameter sets corresponding to the CG-PUSCH transmission, wherein the at least three PC parameter sets include at least a first PC parameter set associated with a normal transmission power, a second PC parameter set associated with a reduced transmission power, and a third PC parameter set associated with a boosted transmission power; and
transmit at least one of:
a priority index corresponding to the CG-PUSCH transmission; or
a first indicator in a group common downlink control information (GC-DCI) message, wherein the first indicator indicates at least one of:
whether the CG-PUSCH transmission can occupy a second set of RBs included in the first set of RBs if the second set of RBs is within a guard band of a user equipment (UE); or
which PC parameter set of the at least three PC parameter sets should be used for transmission power calculation for the CG-PUSCH transmission.

15. A method performed by a user equipment (UE), the method comprising:
receiving at least one of:
a first configuration indicating a first set of resource elements (REs) corresponding to a configured grant physical uplink shared channel (CG-PUSCH) transmission, wherein the first set of REs spans a first set of resource blocks (RBs) in frequency domain; or
a second configuration indicating at least three power control (PC) parameter sets corresponding to the CG-PUSCH transmission, wherein the at least three PC parameter sets include at least a first PC parameter set associated with a normal transmission power, a second PC parameter set associated with a reduced transmission power, and a third PC parameter set associated with a boosted transmission power; and
performing at least one of:
a first determination of whether a second set of RBs included in the first set of RBs is to be occupied by the CG-PUSCH transmission, wherein the second set of RBs is within a guard band; or
a second determination as to which PC parameter set of the at least three PC parameter sets is to be used for transmission power calculation for the CG-PUSCH transmission,
wherein the first determination or the second determination is performed based on at least one of:
a priority index corresponding to the CG-PUSCH transmission;
an indicator received via a group common downlink control information (GC-DCI) message;
a measurement result generated by a measurement procedure associated with cross link interference (CLI); or
a second set of REs used for a downlink physical signal transmission, wherein the second set of REs spans a third set of RBs in frequency domain.

16. A processor for wireless communication, comprising:
at least one controller coupled with at least one memory and configured to cause the processor to:
receive at least one of:
a first configuration indicating a first set of resource elements (REs) corresponding to a configured grant physical uplink shared channel (CG-PUSCH) transmission, wherein the first set of REs spans a first set of resource blocks (RBs) in frequency domain; or
a second configuration indicating at least three power control (PC) parameter sets corresponding to the CG-PUSCH transmission, wherein the at least three PC parameter sets include at least a first PC parameter set associated with a normal transmission power, a second PC parameter set associated with a reduced transmission power, and a third PC parameter set associated with a boosted transmission power; and
perform at least one of:
a first determination of whether a second set of RBs included in the first set of RBs is to be occupied by the CG-PUSCH transmission, wherein the second set of RBs is within a guard band; or
a second determination as to which PC parameter set of the at least three PC parameter sets is to be used for transmission power calculation for the CG-PUSCH transmission,
wherein the first determination or the second determination is performed based on at least one of:
a priority index corresponding to the CG-PUSCH transmission;
an indicator received via a group common downlink control information (GC-DCI) message;
a measurement result generated by a measurement procedure associated with cross link interference (CLI); or
a second set of REs used for a downlink physical signal transmission, wherein the second set of REs spans a third set of RBs in frequency domain.

17. The processor of claim 16, wherein the at least one controller is configured to cause the processor to receive the at least one of the first configuration or the second configuration via a higher layer signaling.

18. The processor of claim 16, wherein the at least one controller is configured to cause the processor to transmit an indicator indicating whether the second set of RBs is determined to be occupied by the CG-PUSCH transmission after the first determination is performed.

19. The processor of claim 18, wherein the indicator is included in a configured grant uplink control information (CG-UCI) associated with the CG-PUSCH transmission.

20. The processor of claim 16, wherein the at least one controller is configured to cause the processor to determine that the second set of RBs is to be occupied by the CG-PUSCH transmission based on at least one of the priority index being equal to or greater than a threshold, or the indicator being set to a first value.
